(19) United States
(12) Patent Application Publication
(10) Pub. No.: US 2021/0398497 A1
(43) Pub. Date: Dec. 23, 2021

(54) BACKLIGHT CONTROL METHOD, DRIVE CIRCUIT FOR DISPLAY PANEL, AND DISPLAY DEVICE

(71) Applicants: HCK CORPORATION LIMITED, Shenzhen (CN); CHONGQING HKC OPTOELECTRONICS TECHNOLOGY CO., LTD., Chongqing (CN)

(72) Inventor: Bin QIU, Chongqing (CN)

(21) Appl. No.: 17/297,450

(22) PCT Filed: Jun. 2, 2020
(86) PCT No.: PCT/CN2020/093904

§ 371 Date: May 26, 2021

(30) Foreign Application Priority Data
Jun. 10, 2019 (CN) 201910497219.X

(51) Int. Cl. G09G 3/34

(52) U.S. Cl. CPC G09G 3/3406; G09G 2330/026; G09G 2370/22; G09G 2320/0252; G09G 2310/08; G09G 2330/12; G09G 2310/0243

(57) ABSTRACT

This application discloses a backlight control method, a drive circuit for a display panel, and a display device. The backlight control method includes steps of: turning on a power supply; and generating an enable signal when detecting whether image data is received, and generating and outputting a first enable signal to control a backlight to turn on if any image data is received, or generating and outputting a second enable signal to control the backlight to turn off if no image data is received.

### CROSS-REFERENCE TO RELATED APPLICATIONS

This application claims priority to Chinese Patent Application No. 201910497219.X, filed with the National Intellectual Property Administration, PRC on Jun. 10, 2019 and entitled “BACKLIGHT CONTROL METHOD, DRIVE CIRCUIT FOR DISPLAY PANEL, AND DISPLAY DEVICE”, which is incorporated herein by reference in its entirety.

### TECHNICAL FIELD

This application relates to the field of display technology, and in particular, to a backlight control method, a drive circuit for a display panel, and a display device.

### BACKGROUND

The description in the background section merely provides background information related to this application, but does not necessarily constitute related art.

A main principle of driving a display device is: a system mainboard connects an R/G/B compression signal, a control signal, and power to a connector (Connector) on a PCB (Printed circuit board) through wires; and, after being processed by a timing control circuit (TCON, Timing Controller) on the printed circuit board, data is connected to a display region through a source drive chip (S-COF, Source-Chip on Film) and a gate drive chip (G-COF, Gate-Chip on Film) by means of the PCB board, so that the display device obtains the required power and signals.

When being powered but without receiving any signal from outside, the timing control circuit determines that there is no signal input, and automatically enters an aging mode. Consequently, at the time of startup, if a signal input is delayed, an aging mode image is displayed first before an image corresponding to the input signal is displayed, thereby deteriorating viewing effects.

### SUMMARY

An objective of this application is to provide a backlight control method for solving startup abnormality, a drive circuit for a display panel, and a display device.

This application discloses a backlight control method, including steps of:

A: turning on a power supply; and

B: detecting whether image data is received; controlling a backlight to turn on if any image data is received, or, controlling the backlight to turn off if no image data is received:

Step B includes the following steps:

B1: generating an enable signal when detecting whether image data is received, and generating and outputting a first enable signal when it is detected that no image data is received, or generating and outputting a second enable signal when it is detected that any image data is received; and

B2: receiving and recognizing, by a backlight control circuit of a display panel, the enable signal, and controlling the backlight to turn off if the enable signal is the first enable signal, or controlling the backlight to turn on if the enable signal is the second enable signal.

This application further discloses a drive circuit for a display panel. The drive circuit includes a timing control circuit and a backlight control circuit. The timing control circuit detects whether image data is received, and controls the backlight control circuit to turn on a backlight if the timing control circuit has received any image data, or controls the backlight control circuit to turn off the backlight if the timing control circuit receives no image data. An enable signal pin is disposed on the timing control circuit. The backlight control circuit is connected to the enable signal pin. The timing control circuit generates an enable signal when detecting whether image data is received. When it is detected that no image data is received, the timing control circuit generates a first enable signal and outputs the first enable signal to the enable signal pin. When it is detected that any image data is received, the timing control circuit generates a second enable signal and outputs the second enable signal to the enable signal pin. Correspondingly, the backlight control circuit receives and recognizes the enable signal, and controls the backlight to turn off if the enable signal is the first enable signal, or controls the backlight to turn on if the enable signal is the second enable signal.

This application further discloses a display device, including a display panel and the foregoing drive circuit. The drive circuit drives the display panel. The drive circuit includes a timing control circuit and a backlight control circuit. The timing control circuit receives image data, and drives the display panel to display an image. The timing control circuit controls, by transmitting an enable signal to the backlight control circuit, a backlight to turn on or turn off.

This application sets up a backlight control mechanism applied at the time of startup. If a signal is delayed during the startup, the turn-on or turn-off of the backlight can be controlled by detecting whether any image data is received. The backlight is turned on immediately if any image data is received, so that a user can see the displayed image at an earliest possible time. If no image data is received, the backlight is turned off in advance. In this way, the aging mode caused by the signal delay of the image data is not seen, thereby enhancing viewing effects significantly and improving visual experience for the user.

### BRIEF DESCRIPTION OF DRAWINGS

The drawings outlined below constitute a part of the specification and are intended to enable a further understanding of the embodiments of this application, illustrate the embodiments of this application, and expound the principles of this application with reference to the text description. Apparently, the drawings outlined below are merely a part of embodiments of this application. A person of ordinary skill in the art may derive other drawings from the drawings without making any creative efforts. In the drawings:

FIG. 1 is a schematic diagram of a display device according to an embodiment of this application;

FIG. 2 is a schematic diagram of a backlight control method according to an embodiment of this application;

FIG. 3 is a schematic diagram of a timing control circuit according to an embodiment of this application;

FIG. 4 is a schematic diagram of a drive circuit according to an embodiment of this application;

FIG. 5 is a schematic flowchart of a backlight control method according to an embodiment of this application;

FIG. 6 is a schematic diagram of a drive time sequence according to an embodiment of this application;

FIG. 7 is a schematic diagram of a timing control circuit according to another embodiment of this application;

FIG. 8 is a schematic flowchart of a backlight control method according to another embodiment of this application;

FIG. 9 is a schematic diagram of a drive time sequence according to an embodiment of this application; and

FIG. 10 is a schematic diagram of a drive time sequence according to another embodiment of this application.

### DETAILED DESCRIPTION OF EMBODIMENTS

It needs to be understood that the terms, specific structures, and function details disclosed herein are merely intended for describing specific embodiments and are representative. However, this application may be specifically implemented in many substitutional forms, but is not to be construed as being limited to the embodiments described herein.

In the context of this application, the terms “first” and “second” are used merely for descriptive purposes but are not to be construed as indicating relative importance or implicitly specifying the quantity of technical features indicated. Therefore, unless otherwise specified, a feature qualified by “first” or “second” may explicitly or implicitly include one such feature or a plurality of the features. A “plurality of” means two or more. The terms “include” and “comprise” and any variations thereof mean non-exclusive inclusion, and may indicate existence or addition of one or more other features, integers, steps, operations, units, components, and/or any combinations thereof.

In addition, the terms indicating a direction or a positional relationship, such as “center”, “transverse”, “upper”, “lower”, “left”, “right”, “vertical”, “horizontal”, “top”, “bottom”, “inner”, and “outer”, are a description based on the direction or relative positional relationship shown in the drawings, and are merely intended for ease or brevity of description of this application, but do not indicate that the indicated device or component must be located in the specified direction or constructed or operated in the specified direction. Therefore, such terms are not to be understood as a limitation on this application.

In addition, unless otherwise expressly specified and qualified, the terms “mount”, “concatenate”, and “connect” need to be understood in a broad sense, for example, understood as a fixed connection, a detachable connection, or an integrated connection; as a mechanical connection or an electrical connection; as a direct connection or an indirect connection implemented through an intermediary; or as interior communication between two components. A person of ordinary skill in the art can understand the specific meanings of the terms in this application according to the context.

The following describes this application in further detail with reference to drawings and optional embodiments.

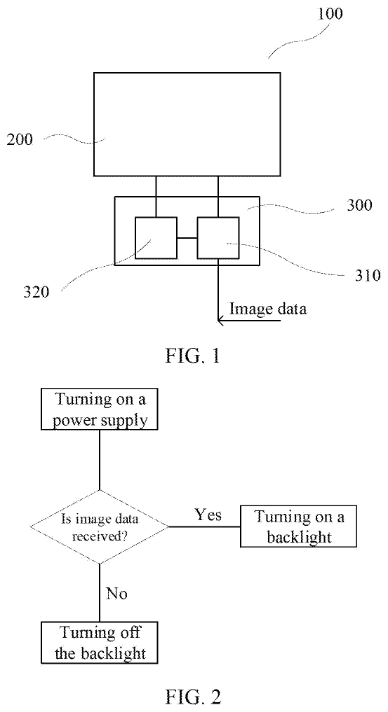

As shown in FIG. 1, an embodiment of this application discloses a display device 100, including a display panel 200 and a drive circuit 300. The drive circuit 300 drives the display panel 200. The drive circuit 300 includes a timing control circuit 310 and a backlight control circuit 320. The timing control circuit is coupled to the backlight control circuit, An output terminal of the timing control circuit is connected to a control terminal of the backlight control circuit. The timing control circuit 310 controls the backlight control circuit 320 by detecting whether panel image data (panel data, PD) is received, whereby a backlight is controlled to turn on or turn off.

Correspondingly, as shown in FIG. 2, at the time of turning on a power supply, if the timing control circuit has received any image data, the timing control circuit controls the backlight control circuit to turn on the backlight so that an image is displayed normally. If the timing control circuit receives no image data, the timing control circuit controls the backlight control circuit to turn off the backlight to prevent start of an aging mode (aging mode). In this way, the user is precluded from seeing the aging pattern, and deterioration of viewing effects is avoided.

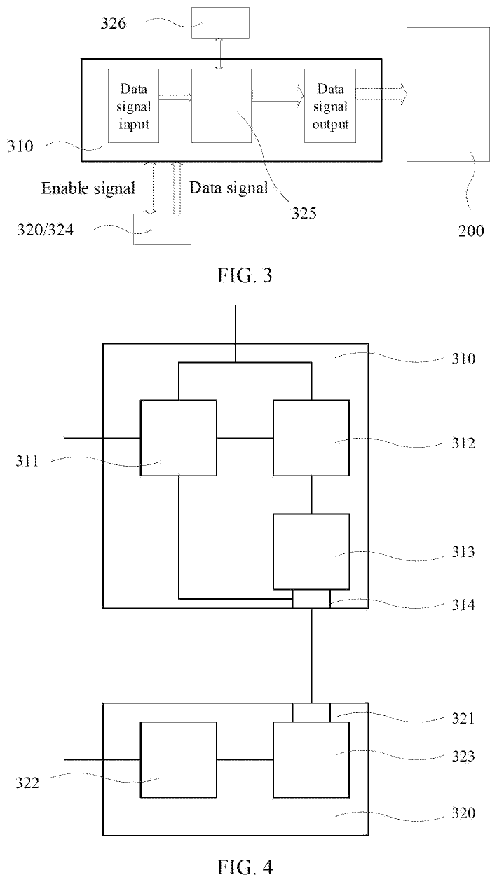

As shown in FIG. 3, a pin (not shown in the drawing) configured to generate an enable signal is disposed on the timing control circuit 310. The backlight control circuit 320 is connected to the pin configured to generate the enable signal. The backlight control circuit 320 includes a core board 324. A pin configured to receive the enable signal is disposed in a position on the core board 324, where the position corresponds to the pin configured to generate the enable signal and disposed on the timing control circuit 310. The timing control circuit 310 detects whether an enable signal corresponding to turn-on or turn-off of the backlight control circuit is generated at the pin configured to generate an enable signal. Specifically, the timing control chip receives image data information (data), and outputs image data to the display panel by means of a signal data processing circuit 325. The signal data processing circuit primarily processes the data according to a data recording circuit 326 (memory). The timing control circuit detects whether image data is received, and generates a corresponding enable signal if any image data is received. The core board 324 receives the enable signal of the timing control circuit to control the core board of the backlight control circuit, so as to control the backlight to turn on. If no image data is received, a corresponding enable signal is generated to disconnect a corresponding enable signal pin, and the core board 324 stops receiving enable signals of the timing control circuit, In this way, the core board of the backlight control circuit controls the backlight to turn off.

To facilitate testing, we set an aging mode for testing. Some test images or pictures may be stored in the aging mode, so that the panel can be tested in the aging mode conveniently. If we choose to enter the aging mode, the timing control circuit will detect whether image data is received. When it is detected that no image data is received, the timing control circuit generates a first enable signal and outputs the first enable signal to the backlight control circuit, and disconnects the enable signal pin simultaneously. This is equivalent to disconnecting the timing control circuit from the backlight control circuit. When it is detected that any image data is received, the timing control circuit generates a second enable signal and outputs the second enable signal to the backlight control circuit. The backlight control circuit receives and recognizes the enable signal, and, if the enable signal is the first enable signal, controls the backlight to turn off, and exercises control to output a preset image for displaying; or, if the enable signal is the second enable signal, controls the backlight to turn on to display the image normally. The first enable signal is a high-level enable signal (enable high), and the second enable signal is a low-level enable signal (enable low). The high-level enable signal controls the backlight to turn off, and the low-level enable signal controls the backlight to turn on, thereby reducing power consumption.

Another embodiment of this application differs from the foregoing embodiment in the following aspect: as shown in FIG. 4, the timing control circuit 310 includes an aging mode control circuit 311, an image data detection circuit 312, an enable signal generation circuit 313, and an enable signal pin 314. The image data detection circuit 312 is coupled to the aging mode control circuit 311. The enable signal generation circuit 313 is coupled to the image data detection circuit 312. The enable signal pin 314 receives the enable signal generated by the enable signal generation circuit 313, and sends the enable signal to the backlight control circuit.

The aging mode control circuit 311 detects whether the aging mode is started, and, if the aging mode is started, disconnects the enable signal pin 314 and exercises control to output a preset image for displaying. The image data detection circuit 312 outputs a first enable signal to the enable signal pin when it is detected that no image data is received, and outputs a second enable signal to the enable signal pin when it is detected that any image data is received. It needs to be noted that the preset image may be a commonly used test image or picture.

The backlight control circuit 320 includes a receiving pin 321 connected to the enable signal pin 314, a switch circuit 322 configured to control the backlight to turn on or off, and a determining circuit 323 connected to the receiving pin 321 and configured to control connection to the switch circuit. The determining circuit 323 receives and recognizes the enable signal of the receiving pin 321, and controls the switch circuit 322 to turn off the backlight if the enable signal is the first enable signal, or controls the switch circuit 322 to turn on the backlight if the enable signal is the second enable signal or if the enable signal is interrupted. The receiving pin of the backlight control circuit is a receiving pin of the enable signal, and is also a pin to be detected. The timing control circuit detects whether the receiving pin corresponds to any enable signal, and, if the receiving pin corresponds to no enable signal, may disconnect the receiving pin to stop receiving enable signals of the timing control circuit.

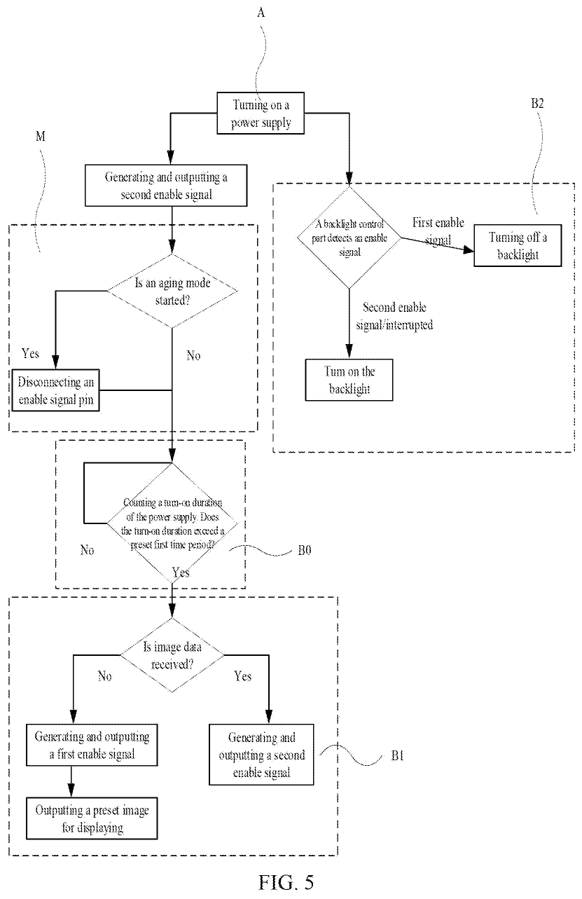

As shown in FIG. 5, another embodiment of this application discloses a backlight control method. The backlight control method includes:

A: turning on a power supply; and

B: detecting whether image data is received; controlling a backlight to turn on if any image data is received, or, controlling the backlight to turn off if no image data is received.

The detection is mainly performed by the timing, control circuit. If any image data is received, the timing control circuit controls the backlight to turn on. If no image data is received, the timing control circuit controls the backlight to turn off. The timing control circuit controls the backlight to turn on or turn off by performing intelligent detection. The timing control circuit may control a backlight control circuit to keep the backlight always off. To be specific, at the time of turning on the power supply. the backlight may be kept off until any image data is received. When no image data (data) is received, a display panel will not make a user feel uncomfortable even if the backlight is turned on. The user feels uncomfortable when a signal is disordered and the display panel is abnormal due to signal transmission and interference before received image data arrives. Therefore, to provide the user with more comfortable experience of timely feedback, we turn on the backlight first, and do not turn off the backlight until an abnormal image is about to appear soon before the received image data is about to arrive soon.

Specifically, in step B, a backlight switch may be controlled by different enable signals generated. The turn-on and turn-off of the backlight are controlled more accurately by the enable signals, including:

B1: generating an enable signal when detecting whether image data is received, and generating and outputting a first enable signal when it is detected that no image data is received, or generating and outputting a second enable signal when it is detected that any image data is received; and

B2: receiving and recognizing, by a backlight control circuit of a display panel, the enable signal, and controlling the backlight to turn off if the enable signal is the first enable signal, or controlling the backlight to turn on if the enable signal is the second enable signal.

In the foregoing step of turning on the power supply, generally a 12 V power supply is turned on. The power supply with a voltage value of 12 V is selected mainly because a power supply above 12 V causes too much power consumption, and a power supply below 12 V provides a voltage that is too low to operate some components. Step B2 is equivalent to a judgment mechanism to primarily determine whether the enable signal is a first enable signal. It needs to be noted that the order between step B1 and step B2 above is not limited. Step B1 may be performed before step B2, or step B2 may be performed before step B1, or the two steps may be performed simultaneously.

To further improve this method and facilitate testing, the following step may be added after step A:

M: detecting whether an aging mode is started, and disconnecting an enable signal pin and performing step B if the aging mode is started, or performing step B directly if the aging mode is not started.

Correspondingly, in step B1, when it is detected that no image data is received, the following step is performed while outputting the first enable signal: exercising control to output a preset image for displaying; and, in step B2, the backlight control circuit of the display panel receives and recognizes the enable signal, and controls the backlight to turn off if the enable signal is the first enable signal (enable high), or controls the backlight to turn on if the enable signal is the second enable signal (enable low) or if the enable signal is interrupted. According to such design, the aging mode is preset, and no additional external device is required. It is very convenient to choose whether to perform the aging test or the normal display, without mutual interference.

Before step B1, step B0 is added: counting a turn-on duration of the power supply; when the turn-on duration is within a preset first time period, outputting the second enable signal to the backlight control circuit to keep the backlight on; and, when the turn-on duration exceeds the preset first time period, performing step B1 and outputting the first enable signal to the backlight control circuit to control the backlight to turn off. A length of the first tune period is generally a length of one frame of the corresponding data image of the display panel. An initialization process is required in displaying a test image in the aging mode. Therefore, to improve user experience by giving timely feedback, the backlight may be turned on first. The backlight is not turned off until the test image in the aging mode is about to appear soon. In addition, the timing control circuit inherently stores related data information whose time length is one frame, without a need to reset new parameters, thereby being very convenient. Inherent functions of the timing control circuit are fully utilized, and use of the timing control circuit is maximized.

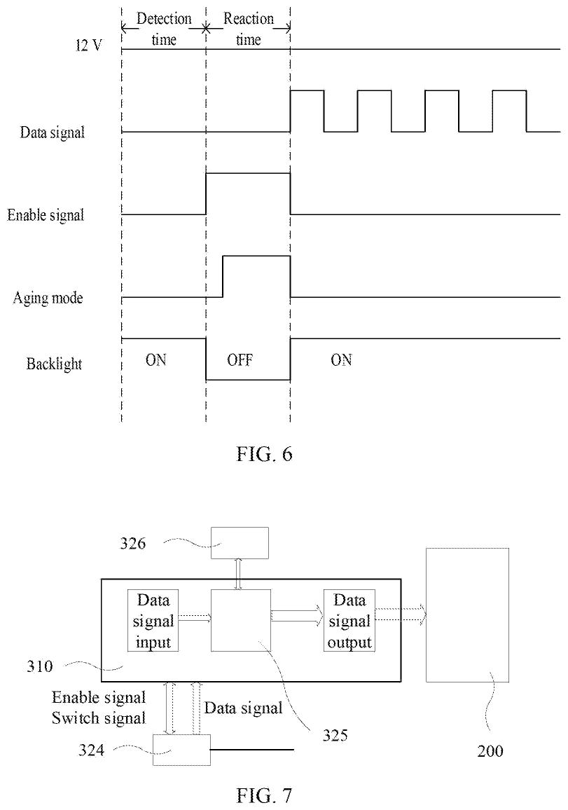

As shown in FIG. 6, the power supply remains on. A duration from turn-on of the power supply to occurrence of the aging mode (aging mode) is used as a detection time of the timing control chip. The detection time is set mainly with reference to a general time length required from the turn-on of the power supply of the display panel to start of the aging mode. A length of the detection time may be less than or equal to the time length required from the turn-on of the power supply of the display panel to the start of the aging mode. During the detection time, if no image data (data) is received, the timing control circuit generates a second enable signal (enable low), and the backlight control circuit receives the second enable signal and turns on the backlight. After the detection time, a reaction time exists. If still no image data is received within the reaction tune but the aging mode is about to come soon, the timing control circuit generates a first enable signal (enable high). The backlight control circuit receives the first enable signal generated by the timing control circuit, and turns off the backlight. When the image data is received, the timing control circuit generates a second enable signal, and the backlight control circuit receives the second enable signal and turns on the backlight. The timing control circuit is started and generates different enable signals at specific time and under specific conditions to control the backlight to turn off or turn on. Therefore, the user is precluded from seeing an abnormal image caused by signal delay, and user experience is not affected.

Especially, a time period is reserved within the reaction time. To be specific, the length of the detection time is set to be shorter than the time length required from the turn-on of the power supply of the display panel to the start of the aging mode. In this way, the backlight is turned off in advance to prevent backlight turn-off delay caused by abnormal transmission of the enable signal. This precludes the user from seeing an aging mode image, and avoids deterioration of user experience. In addition, if the image data arrives within the reserved time period, an operation of turning off the backlight is not required, thereby saving startup time and enabling the user to see a displayed image faster than usual.

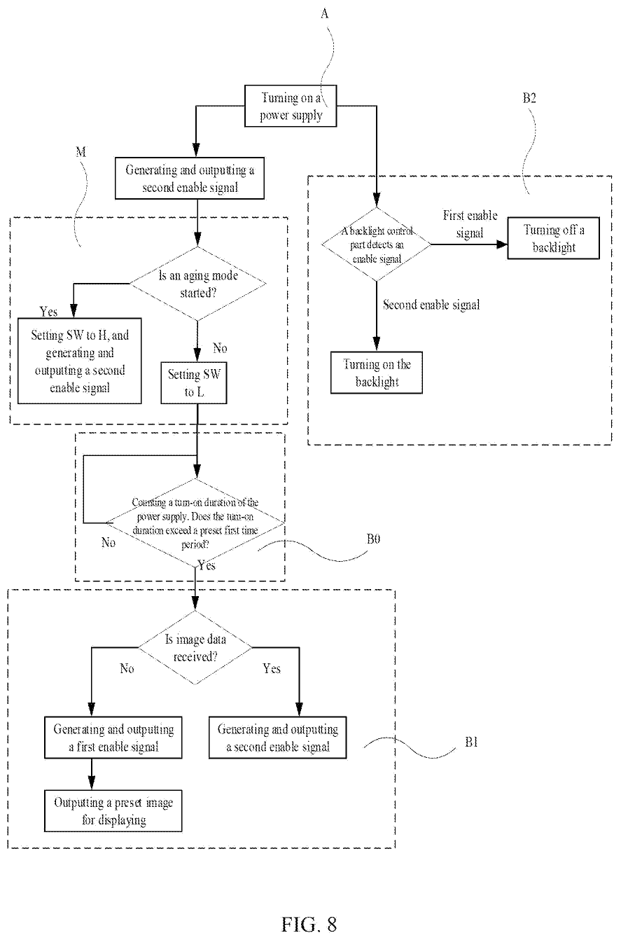

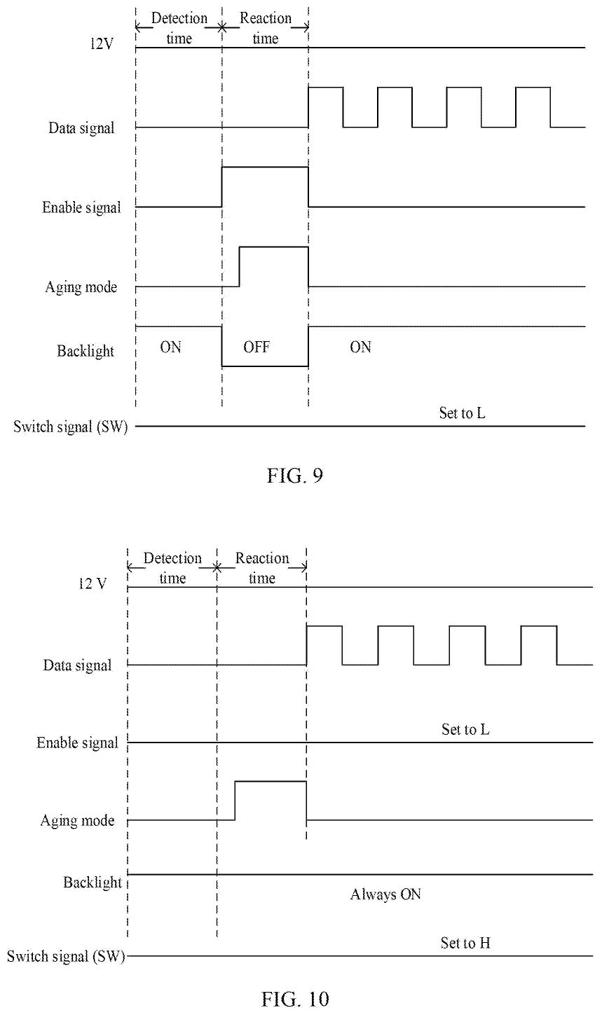

In one or more embodiments of this application, as shown in FIG. 7 to FIG. 10, a switch signal pin is further disposed on the core board 324. The switch signal pin outputs a switch signal (SW). As a difference from the foregoing embodiment, the following step is added after step A:

M: detecting whether an aging mode is started, and setting, by the timing control circuit if the aging mode is started, the switch signal to L, and directly generating and outputting the second enable signal, and skipping step B, or setting, by the timing control circuit if the aging mode is not started, the switch signal to H, and performing step B.

Correspondingly, in step B1, when it is detected that no image data is received, the following step is performed simultaneously when outputting the first enable signal: exercising control to output a preset image for displaying.

Correspondingly, in step B2, the backlight control circuit of the display panel receives and recognizes the enable signal, and controls the backlight to turn off if the enable signal is the first enable signal, or controls the backlight to turn on if the enable signal is the second enable signal or no enable signal is recognized.

A switch signal pin is added, and a high-level signal and a low-level signal are set correspondingly. To avoid a falsely triggered aging mode, the SW is set to L, and the 12 V power supply is turned on. When the timing control circuit works but detects no first enable signal output by the core board, the timing control circuit detects the turn-on duration of the 12 V power supply. When the turn-on duration exceeds a preset length of one frame (before the aging mode is started), the enable signal changes from Low to High, and the timing control circuit feeds back an Enable High signal to the core board. The core board turns off the backlight after recognizing the signal. When the timing control circuit receives the second enable signal, the Enable signal changes from High to Low. The timing control circuit then feeds back an Enable Low signal to the core board, and the core board turns on the backlight after recognizing the signal. In this way, the user will not see the aging pattern caused by signal delay. When the user needs to start the aging mode, the SW is set to H, the enable pin is set to L, and the backlight is always on. When no external signal is input, the aging mode is started. This design prevents the user from seeing the test-purpose aging pattern when no signal is input, and saves power consumption. This designed mode can be deactivated when the aging mode is required, so that flexible selection is provided. In addition, the enable signal pin on the timing control circuit does not need to be disconnected, thereby reducing workload of the timing control circuit and increasing a service life.

It needs to be noted that, to the extent that the implementation of the specific solution is not affected, no limitation on a step in this solution is considered to be a limitation on the order of steps. A step written before another step may be performed before or after the other step, or even performed simultaneously. All variations capable of implementing this solution fall within the protection scope of this application. In addition, as far as practicable, one or more of the foregoing embodiments may be combined.

The technical solution of this application is widely applicable to various display panels, for example, a twisted nematic (twisted nematic, TN) display panel, an in-plane switching (in-plane switching, IPS) display panel, a vertical alignment (vertical alignment, VA) display panel, and a multi-domain vertical alignment (multi-domain vertical alignment, MVA) display panel, and may also be applicable to other types of display panels such as an organic light-emitting diode (organic light-emitting diode, OLEO) display panel.

The foregoing content is a detailed description of this application made with reference with specific optional embodiments, but the specific implementation of this application is not limited to such description. Simple derivations or replacements may be made by a person of ordinary skill in the art of this application without departing from the conception of this application, and all such derivations and replacements fall within the protection scope of this application.

What is claimed is:

1. A backlight control method, wherein the backlight control method comprises steps of:
A: turning on a power supply; and
B: detecting whether image data is received; controlling a backlight to turn on if any image data is received, or, controlling the backlight to turn off if no image data is received; wherein
Step B comprises the following steps:
B1: generating an enable signal when detecting whether image data is received, and generating and outputting a first enable signal when it is detected that no image data is received, or generating and outputting a second enable signal when it is detected that any image data is received; and
B2: receiving and recognizing, by a backlight control circuit of a display panel, the enable signal, and controlling the backlight to turn off if the enable signal is the first enable signal, or controlling the backlight to turn on if the enable signal is the second enable signal.

2. The backlight control method according to claim 1, wherein in the step of turning on the power supply, the step of controlling the backlight to turn on is performed simultaneously when turning on the power supply.

3. The backlight control method according to claim 1, wherein, after step A, the method further comprises a step of
M: detecting whether an aging mode is started, and performing step B and disconnecting an enable signal pin if the aging mode is started, or performing step B directly if the aging mode is not started; wherein
Correspondingly, in step B1: when it is detected that no image data is received, the following step is performed simultaneously when outputting the first enable signal: exercising control to output a preset image for displaying,
Correspondingly, in step B2: the backlight control circuit of the display panel receives and recognizes the enable signal, and controls the backlight to turn off if the enable signal is the first enable signal, or controls the backlight to turn on if the enable signal is the second enable signal or no enable signal is recognized.

4. The backlight control method according to claim 1, wherein, after step A, the method further comprises a step of:
M: detecting whether an aging mode is started, and directly generating and outputting the second enable signal and skipping step B if the aging mode is started, or performing step B if the aging mode is not started, wherein
in step B1 : when it is detected that no image data is received, the following step is performed simultaneously when outputting the first enable signal: exercising control to output a preset image for displaying; and
in step B2: the backlight control circuit of the display panel receives and recognizes the enable signal, and controls the backlight to turn off if the enable signal is the first enable signal, or controls the backlight to turn on if the enable signal is the second enable signal or if no enable signal is recognized.

5. The backlight control method according to claim , wherein, before step B1, the method further comprises a step of:
B0 counting a turn-on duration of the power supply; when the turn-on duration is within a preset first tune period, outputting the second enable signal to the backlight control circuit to keep the backlight on; and, when the turn-on duration exceeds the preset first time period, performing step B1.

6. The backlight control method according to claim 5, wherein, after step A, the method further comprises a step of:
M: detecting whether an aging mode is started, and performing step B and disconnecting an enable signal pin if the aging mode is started, or performing step B directly if the aging mode is not started; wherein
in step B1: when it is detected that no image data is received, the following step is performed simultaneously when outputting the first enable signal: exercising control to output a preset image for displaying; and
in step B2: the backlight control circuit of the display panel receives and recognizes the enable signal, and controls the backlight to turn off if the enable signal is the first enable signal, or controls the backlight to turn on if the enable signal is the second enable signal or if the enable signal is interrupted, and a time point of displaying the preset image is later than the first time period.

7. The backlight control method according to claim 6, wherein a length of the first time period is set to a length of one frame.

8. The backlight control method according to claim 1, wherein a time point of turning off the backlight is earlier than a time point of starting the aging mode.

9. The backlight control method according to claim 1, wherein, after step A, the method further comprises a step of:
M: detecting whether an aging mode is started, and setting, by the timing control circuit if the aging mode is started, a switch signal of a switch signal pin to be a low-level signal, and directly generating and outputting the second enable signal, and skipping step B, or setting, by the timing control circuit if the aging mode is not started, a switch signal of a switch signal pin to be a high-level signal, and performing step B.

10. The backlight control method according to claim 1, wherein, after step A, the method further comprises a step of: keeping the backlight always on, and directly entering an aging mode.

11. The backlight control method according to claim 3, wherein, when the aging mode needs to be started, the timing control circuit sets a switch signal of a switch signal pin to be a high-level signal, and directly generates and outputs the second enable signal to keep the backlight always on.

12. A drive circuit for a display panel, wherein the drive circuit comprises:
a timing control circuit; and
a backlight control circuit, configured to control a backlight to turn off or turn on; wherein
the timing control circuit detects whether image data is received, and controls the backlight control circuit to turn on the backlight if the timing control circuit has received any image data, or controls the backlight control circuit to turn off the backlight if the timing control circuit receives no image data.

13. The drive circuit for a display panel according to claim 12, wherein an enable signal pin is disposed on the timing control circuit, and the backlight control circuit is connected to the enable signal pin;
the timing control circuit generates an enable signal when detecting whether image data is received; and, when the timing control circuit detects that no image data is received, generates a first enable signal and outputs the first enable signal to the enable signal pin, or, when the timing control circuit detects that any image data is received, generates a second enable signal and outputs the second enable signal to the enable signal pin; and
correspondingly, the backlight control circuit receives and recognizes the enable signal, and controls the backlight to turn off if the enable signal is the first enable signal, or controls the backlight to turn on if the enable signal is the second enable signal.

14. The drive circuit for a display panel according to claim 12, wherein the timing control circuit comprises:
an aging mode control circuit, configured to control whether to enter an aging mode;
an image data detection circuit, configured to detect whether image data is received, and coupled to the aging mode control circuit;
an enable signal generation circuit, configured to generate an enable signal, and coupled to the image data detection circuit; and
an enable signal pin, configured to receive the enable signal generated by the enable signal generation circuit and send the enable signal to the backlight control circuit; wherein
the aging mode control circuit detects whether the aging mode is started, and, if the aging mode is started, disconnects the enable signal pin of the enable signal generation circuit, and exercises control to output a preset test image for displaying; and
the image data detection circuit outputs a first enable signal to the enable signal pin when it is detected that no image data is received, and outputs a second enable signal to the enable signal pin when it is detected that any image data is received.

15. The drive circuit for a display panel according to claim 14, wherein the backlight control circuit comprises:
a receiving pin, connected to the enable signal pin;
a switch circuit, configured to control the backlight to turn on or off; and
a determining circuit, connected to the receiving pin, and configured to control connection to the switch circuit; wherein
the determining circuit receives and recognizes the enable signal of the receiving pin, and controls the switch circuit to turn off the backlight if the enable signal is the first enable signal, or controls the switch circuit to turn on the backlight if the enable signal is the second enable signal or if the enable signal is interrupted.

16. A display device, comprising a display panel and a drive circuit, wherein the drive circuit drives the display panel, and the drive circuit comprises:
a timing control circuit, configured to receive image data, and drive the display panel to display an image; and
a backlight control circuit, configured to control a backlight to turn on or turn off wherein
the timing control circuit controls, by transmitting an enable signal to the backlight control circuit, the backlight to turn on or turn off.

17. The display device according to claim 16, wherein the timing control circuit comprises:
an aging mode control circuit, configured to control whether to enter an aging mode;
an image data detection circuit, configured to detect whether image data is received, and coupled to the aging mode control circuit;
an enable signal generation circuit, configured to generate an enable signal, and coupled to the image data detection circuit; and
an enable signal pin, configured to receive the enable signal generated by the enable signal generation circuit and send the enable signal to the backlight control circuit; wherein
the aging mode control circuit detects whether the aging mode is started, and, if the aging mode is started, disconnects the enable signal pin of the enable signal generation circuit, and exercises control to output a preset test image for displaying; and
the image data detection circuit outputs a first enable signal to the enable signal pin when it is detected that no image data is received, and outputs a second enable signal to the enable signal pin when it is detected that any image data is received; and
the backlight control circuit comprises:
a receiving pin, connected to the enable signal pin;
a switch circuit, configured to control the backlight to turn on or off; and
a determining circuit, connected to the receiving pin, and configured to control connection to the switch circuit; wherein
the determining circuit receives and recognizes the enable signal of the receiving pin, and controls the switch circuit to turn off the backlight if the enable signal is the first enable signal, or controls the switch circuit to turn on the backlight if the enable signal is the second enable signal or if the enable signal is interrupted.
